(19) United States
(12) Patent Application Publication
(10) Pub. No.: US 2005/0103055 A1
(43) Pub. Date: May 19, 2005

(54) Device and method for dividing vertical glass plates

(75) Inventors: Hans Gfeller, Aarwangen (CH); Irmgard Braun, Sins (CH)

Correspondence Address: FOLEY AND LARDNER;SUITE 500, 3000 K STREET NW, WASHINGTON, DC, 20007, US

(73) Assignee: Bystronic Maschinen AG

(21) Appl. No.: 10/508,338

(22) PCT Filed: Apr. 2, 2003
(86) PCT No.: PCT/CH03/00218

(30) Foreign Application Priority Data
Apr. 4, 2002 (EP) 02405267.2

(51) Int. Cl. B26D 3/08

(52) U.S. Cl. 65/112

(57) ABSTRACT

The device (30, 70) for dividing a glass plate includes a supporting surface (31, 73) for supporting the glass plate in an essentially vertical position and at least one horizontal breaking device (39, 40, 42) for breaking the glass plate along a line that extends essentially horizontally. According to the method for dividing the glass plate that is in an essentially vertical position, the glass plate is broken at the breaking station (30) along a line that extends essentially horizontally during the breaking process.

The invention refers to a device for dividing glass plates according to the preamble of claim 1.

The invention further refers to a method according to the preamble of claim 12.

In cutting and breaking installations of the prior art, the glass plates are processed in the horizontal position. The blank glass plates that are being divided into cut portions of the desired size are usually large-sized. Typically, they have a length of 600 cm and a width of 321 cm. This implies a corresponding design of the processing stations, which however is disadvantageous with regard to the space requirements.

In addition, the glass plates are usually stored in the vertical position, so that a suitable loading device is required for the supply of the known cutting and breaking installations that allows rotating the glass plate into the horizontal position. A rapid loading is therefore difficult to achieve. Also, the rotation of the glass plates requires careful handling to avoid damages.

European patent specification EP-B1-805 784 discloses a device for scoring and breaking glass plates that are disposed essentially vertically. For breaking a portion of a glass plate along a horizontally extending cutting line, a turning station is provided that allows to turn the glass plate portion by 90 degrees such that the cutting line extends vertically for the breaking process. However, to avoid damages during turning, the glass plate portion must be handled carefully, which is laborious especially in the case of large glass plate portions. Another drawback is that an additional operation and thus additional processing time is required, and that the glass plate portion has to be realigned after it has been turned.

Based on this prior art, the object of the present invention is to provide a method and device as mentioned in the introduction providing a simplified handling of the glass plates, particularly in the dividing operation.

According to the invention, this is accomplished by a device according to claim 1 resp. by a method according to the independent method claim.

The dependent claims define preferred embodiments.

The device and the method of the invention offer the following advantages:
(a) they allow a space-saving and simple handling of the glass plates during processing;
(b) loading of the installation is facilitated,
(c) precise alignment of the glass plates is facilitated.

It will be noted that in the following description and in the patent claims, the term “glass plates” is meant to generally include plates containing glass, such as e.g. single glass panes, coated glass panes, laminated glass panes (glass panes with an interposed synthetic foil), multilayer laminated glass panes, laminated safety glass panes, etc.

The invention will be explained hereinafter by means of an exemplary embodiment and with reference to figures, where

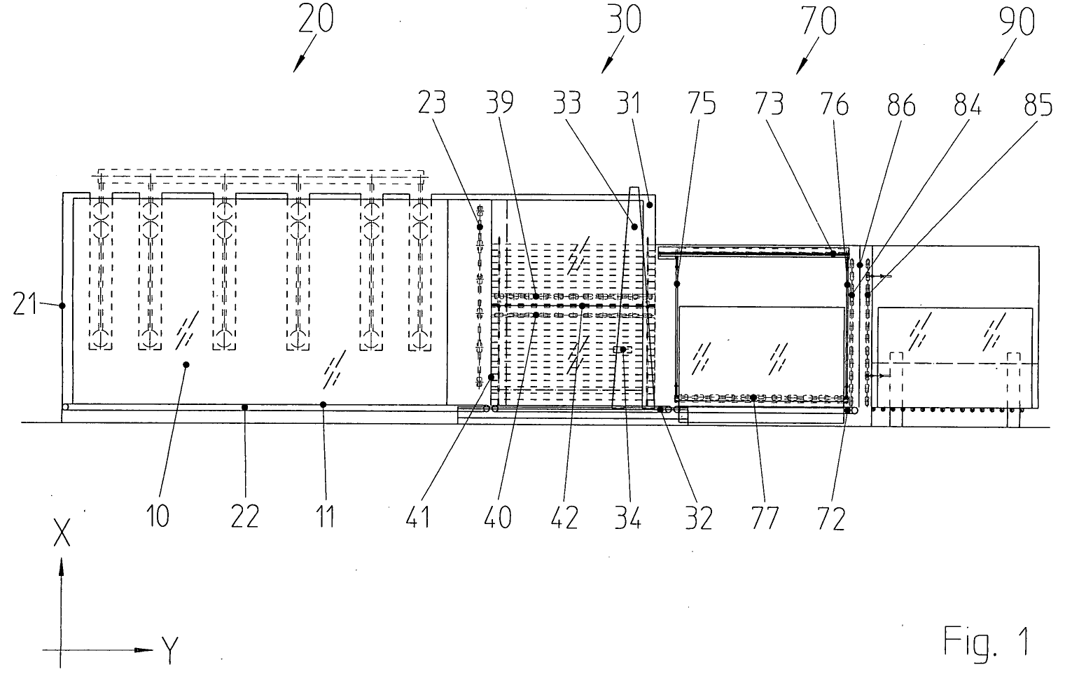

FIG. 1 shows a front view of the installation of the invention,

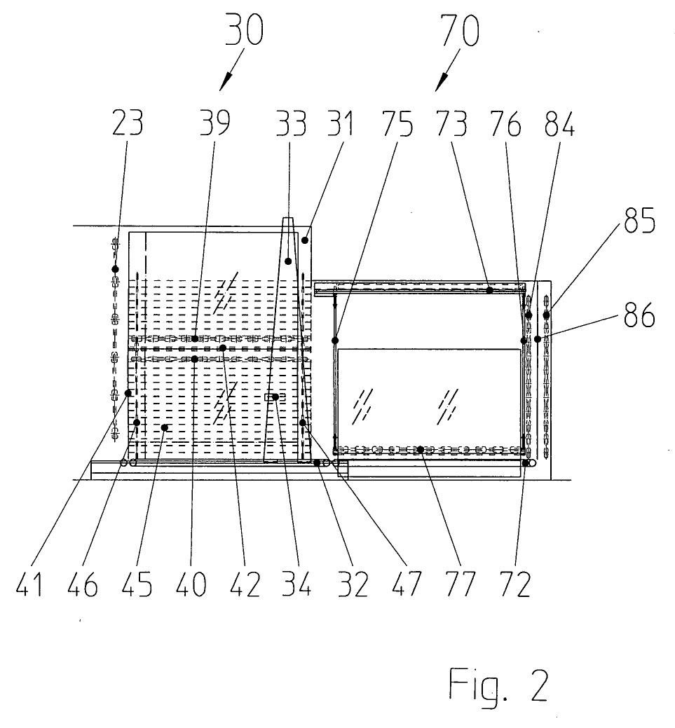

FIG. 2 shows an enlarged view of the cutting and breaking station and of a further breaking station according to FIG. 1,

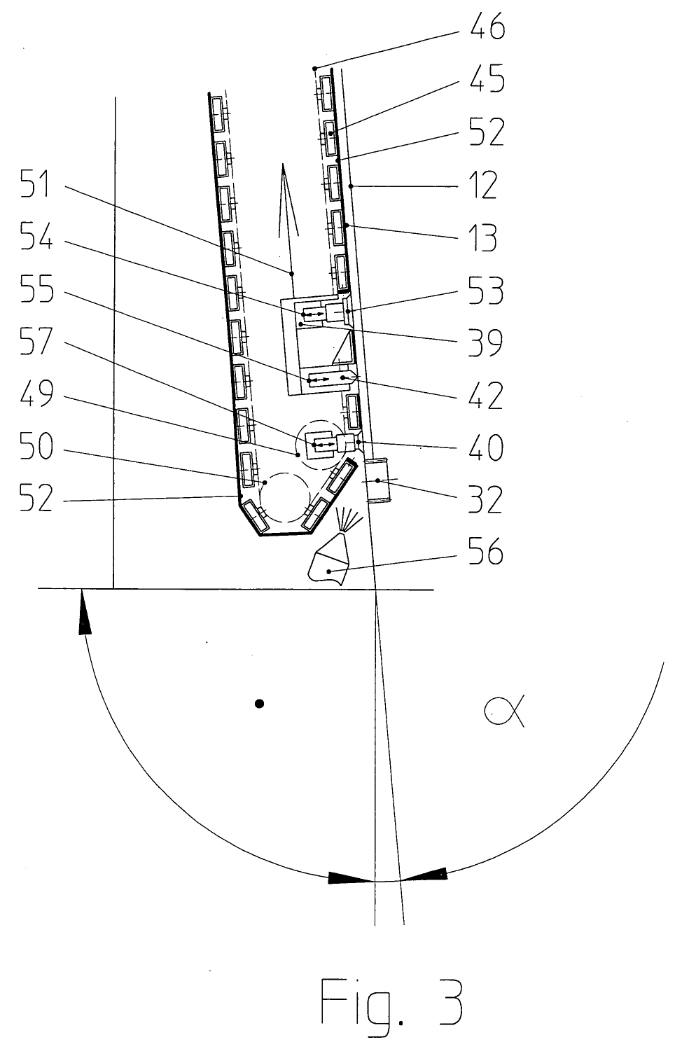

FIG. 3 shows a cross-section along the lower part of the breaking station of FIG. 2,

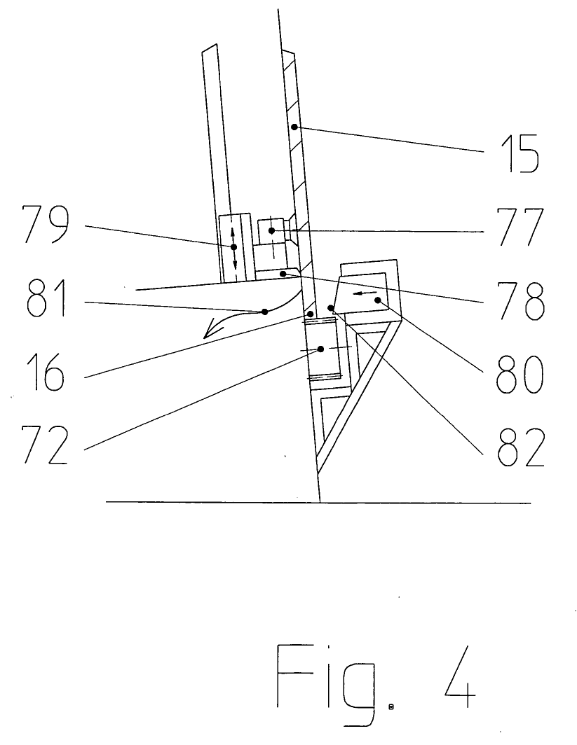

FIG. 4 shows a cross-section along the lower part of the breaking station of FIG. 2, and

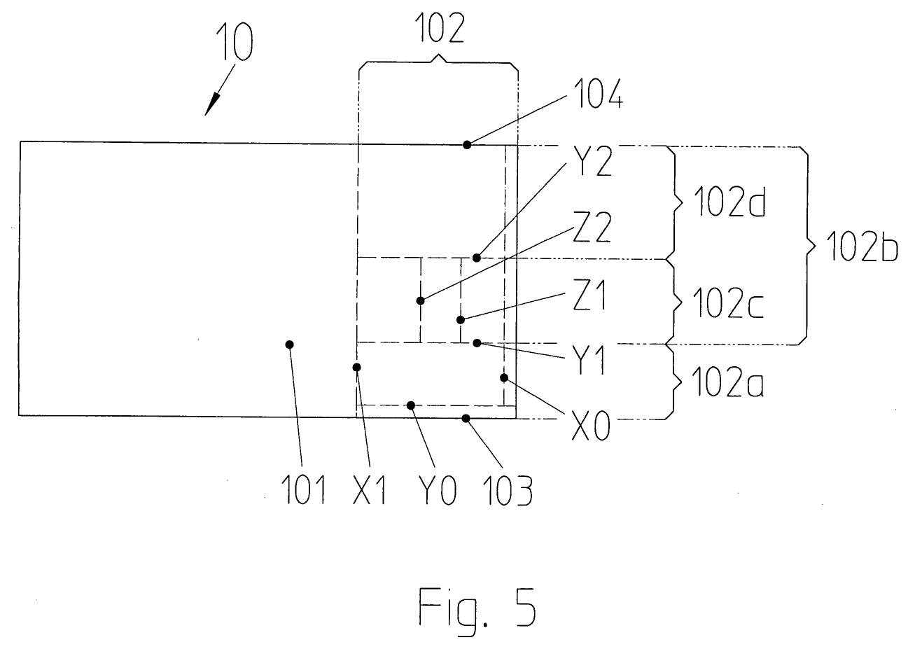

FIG. 5 shows an example of a glass plate provided with scoring lines.

The installation for processing glass plates illustrated in FIG. 1 includes several stations: a feeder station 20, a cutting and breaking station 30, another breaking station 70 and a post-processing station 90.

The installation is designed as a so-called subplate machine, i.e. the glass plate is worked off strip by strip (subplate by subplate) in the y direction. This allows a highly flexible processing particularly of glass plates of different kinds.

Feeder station 20 comprises a first supporting surface 21 for supporting the glass plate 10 to be processed. First supporting surface 21 is arranged essentially vertically, so that the angle (hereinafter designated by alpha) between first supporting surface 21 and the vertical is preferably in the range of 0 to 10 degrees.

The glass plates are usually stored essentially vertically e.g. on storage racks while the angle of inclination is approx. 5 to 7 degrees. Preferably, the angle alpha is chosen similar to the angle of inclination of the stored glass plates so that the glass plates are only displaced translationally and need not be tilted in the process of loading feeder station 20.

First supporting surface 21 may be in the form of an air cushion wall or a roller wall that allows a gliding movement of the glass plate 10 to be processed. At the lower end of feeder station 20, a first conveyor belt 22 is provided that leads to cutting and breaking station 30 in a horizontal direction (also called y direction herebelow).

During the transport of glass plate 10, one edge 11 of the latter rests on conveyor belt 22 while its rear side glides on the rollers resp. on the air cushion of first supporting surface 21, the front side of glass plate 10 being freely accessible at the front.

At the right-hand end of feeder station 20, a first vertical suction bar 23 is provided. Along an essentially vertical line, suction bar 23 is provided with a multiple of suction cups that are applied to the rear side of the processed glass plate from the back and are detachably connectable to the latter by partial vacuum.

The cutting and breaking station 30 that follows feeder station 20 comprises a second supporting surface 31 which is aligned with first supporting surface 21. First conveyor belt 22 is followed at the lower end of cutting and breaking station 30 by a second conveyor belt 32.

A cutting bridge 33 which is displaceable in the y direction is positioned at the front side of second supporting surface 31. It is provided with a cutting tool (cutting wheel or laser) which is displaceable in the x direction and may additionally comprise a pivot for rotating the cutting tool. By means of the cutting tool, the front side of the glass plate can be provided with scoring lines along which it will subsequently be broken into separate pieces of the desired size. In addition to rectangular shapes, the cutting tool also allows scoring freely selectable shapes. Cutting bridge 33 may further be equipped with additional tools for processing the glass plate which are preferably displaceable in the x direction and may also comprise a pivot. Thus, it is e.g. conceivable to provide a grinding device e.g. for removing the coating of a coated glass plate in certain locations, or a drilling device for providing the glass plate with holes in certain locations.

As shown schematically in FIG. 2, the cutting bridge is equipped with a gripper 34 for seizing a glass plate by its right-hand edge and for a precise positioning thereof by displacement of cutting bridge 33 in the y direction.

The second supporting surface 31 of cutting and breaking station 30 is provided with a first horizontal suction bar 39 and preferably with a second horizontal suction bar 40. Similarly to the first vertical suction bar 23, the two suction bars 39 and 40 are provided with a multiple of suction cups for a detachable connection to the glass plate.

A first vertical break bar 41 is mounted between the first vertical suction bar 23 and the left-hand end of the two horizontal suction bars 39 and 40. It can be applied to the rear side of the glass plate from the back in order to break the latter along a vertical scoring line (so-called “X-cut”).

Between the two horizontal suction bars 39 and 40, a first horizontal break bar 42 is mounted that allows to break the glass plate resp. a portion thereof along a horizontal scoring line (so-called “Y-cut”).

First horizontal break bar 42 and the two horizontal suction bars 39 and 40 are displaceable in the x direction in order to be able to break the glass plate resp. a portion thereof along any horizontally extending scoring line. The two horizontal suction bars 39 and 40 also serve for holding the glass plate resp. the upper portion of the divided glass plate and for lowering the same.

As illustrated in FIG. 2 by the dashed lines, second supporting surface 31 is provided with a multiple of bars 45 extending across its entire width essentially. Together with first horizontal break bar 42 and the two horizontal suction bars 39 and 40, bars 45 are connected to each other in the left-hand and right-hand border area of cutting and breaking station 31 by vertically extending chains 46 and 47, respectively, thereby forming a kind of revolving jalousie that is displaceable in the x direction.

Bars 45 are made of a rigid material, e.g. of metal, such that second supporting surface 31 forms a rigid wall providing a corresponding support of the glass plate. It is thus ensured that the pressure applied by the cutting tool to the front side of the glass plate during the cutting operation is absorbed by second supporting surface 31 and that the glass area around the scoring lines is not damaged by excessive stresses.

FIG. 3 shows a cross-section of the lower part of cutting and breaking station 30. As described above, the rear side of the glass plate rests on second supporting surface 31. The latter is arranged essentially vertically, so that the angle alpha between the vertical and the second supporting surface is preferably in the range of 0 to 10 degrees.

The individual bars 45 are articulated on chains 46 and 47, which are deflected in the lower area of the cutting and breaking station by two rollers 49 and 50, respectively. Similarly, two additional (non-represented) rollers are provided for deflecting the chains 46 and 47 in the upper area of second supporting surface 31.

Furthermore, bars 45 are lined with a flexible supporting mat 52, consisting e.g. of a band of fabric that is preferably coated with plastics material. Supporting mat 52 extends across the entire width of bars 45 essentially, thereby supporting glass plate 12 while it is being scored.

When first horizontal break bar 42 is displaced vertically upwards together with the two horizontal suction bars 39 and 40, as indicated in FIG. 3 by arrow 51, the bars are continuously deflected by the rollers and appear on the front side. As indicated in FIG. 3 by double arrows 54, 55, and 57, the respective suction heads 53 on first horizontal suction bar 39, the suction heads on second horizontal suction bar 40, and break bar 42 are displaceable transversally to the surface of glass plate 12 in order to avoid that they strike the rear side 13 of glass plate 12 during the displacement.

At the lower end of cutting and breaking station 30, a multiple of air nozzles 56 are mounted along a horizontal direction. Through these nozzles, air can be injected between supporting mat 52 and glass plate 12. Since supporting mat 52 forms an air-tight surface, the air will flow from the bottom upwards between supporting mat 52 and glass plate 12 and thus form an air cushion on which the lower portion of glass plate 12 may glide while it is forwarded to breaking station 70 after the Y-breaking.

As appears in FIG. 2, the additional breaking station 70 follows cutting and breaking station 30. In alignment with second conveyor belt 32, a third conveyor belt 72 is arranged at the lower end of breaking station 70. Breaking station 70 is provided with a fourth conveyor belt 73 which, guided by left-hand and right-hand rails 75 and 76, respectively, is displaceable in the x direction. Depending on the width of the cut portion of the glass plate, fourth conveyor belt 73 is positioned at the corresponding height, so that the glass plate may glide thereon. Breaking station 70 is provided with a third horizontal suction bar 77.

As shown in FIG. 4, suction bar 77 is equipped at its lower end with a counterpressure bar 78 and is displaceable along the vertical, as indicated by double arrow 79. A second horizontal break bar 80 is mounted on the front side of glass plate 15.

Breaking device 77, 78, and 80 is used for breaking off a strip at the lower edge of glass plate 15 (so-called “Y trim”), if necessary. (Since the glass plate blanks usually do not have clean edges, it is necessary to eliminate the edge trim.)

In order to break off the Y trim, the third horizontal suction bar 77 is displaced in the x direction until counterpressure bar 78 is positioned on the corresponding scoring line of the Y trim. Second horizontal break bar 80 is then pressed against the front side of glass plate 15 from the front so that the Y trim finally breaks off and, as indicated by arrow 81, falls off to the back.

As appears in FIG. 4, second horizontal break bar 80 has a wedge-shaped cross-section, thereby allowing front edge 82 to be applied as close to the edge 16 of glass plate 15 as possible. It is thereby ensured that the distance between counterpressure bar 78 and the front edge 82 of second horizontal break bar 80 is as large as possible and that a maximum bending moment is achieved in the breaking operation.

While breaking the Y trim, third horizontal suction bar 77 maintains glass plate 15 in its position, and after the removal of the Y trim, it is displaced downwards together with glass plate 15 such that the just broken edge of the latter comes to rest on third conveyor belt 72.

Optionally, for breaking off the Y trim at the upper edge of glass plate 15, another breaking device that is similar to breaking device 77, 78, and 80 and displaceable in the x direction may be provided along fourth conveyor belt 73.

For breaking the glass plate along another vertical scoring line (so-called “Z-cut”), breaking station 70 comprises a second vertical suction bar 84 at the end of third conveyor belt 72 and a third vertical suction bar 85 as well as a second vertical break bar 86. In addition to Z-cuts, this breaking device 84, 85, and 86 allows to remove a strip at the left resp. right edge of the glass plate (the so-called “X trim”), if necessary.

Breaking station 70 may be followed by a post-processing station 90, as illustrated in FIG. 1. The latter may e.g. include a tilting table that allows tilting the glass plate to the horizontal position for manual treatments.

Subsequently, at the end of the installation, the glass portions are e.g. set down on storage racks, (manually or automatically) sorted in compartment carriages, temporarily stored in an intermediate storage or directly forwarded to another processing line.

The following method can be performed in the installation according to the invention:

The glass plate to be processed is supplied e.g. from a storage rack or a subplate loader to feeder station 20 by means of a loading device.

By means of first conveyor belt 22, the glass plate is transferred to cutting and breaking station 30, where it is positioned in the y direction on second supporting surface 31 by gripper 34 such that first vertical break bar 41 and the vertical scoring line provided for the X cut coincide.

First vertical suction bar 23 and the two horizontal suction bars 39 and 40 are applied to the glass plate and secure it by vacuum.

The glass plate or a portion thereof is then cut by means of the cutting tool. Before the breaking operation, the glass plate may optionally be processed in further operations such as drilling or grinding.

FIG. 5 shows an example where the right-hand portion 102 of glass plate 10 (so-called “subplate”) is provided with scoring lines X0, X1, Y0, Y1, Y2, Z1 and Z2. Hereinafter, for the sake of simplicity, the further operations will be explained in more detail with reference to FIG. 5, which however only represents one possible example of dividing the glass plate. It is understood that the different operations will be correspondingly adapted according to the desired partitioning of the glass plate.

After the cutting operation, glass plate 10 is broken into two portions 101 and 102 along line X1 by means of first vertical break bar 41.

In the next processing step, first horizontal break bar 42 is displaced in the x direction until it is positioned at the height of scoring line Y1. Then the two horizontal suction bars 39 and 40 are firmly connected to subplate 102 by vacuum and subsequently moved a little upwards so that a small space is formed between the lower edge 103 of subplate 102 and second conveyor belt 32, the space being e.g. in the order of the thickness of glass plate 10.

For the breaking operation, first horizontal break bar 42 is advanced toward subplate 102 while the two horizontal suction bars 39 and 40 support subplate 102 until it finally breaks into two portions 102a and 102b.

As described above, before the breaking operation, subplate 102 is lifted a little so that the lower edge 103 is no longer resting on second conveyor belt 32 and is therefore relatively freely movable. In addition, the separation of lower portion 102a from upper portion 102b is assisted by gravity, so that a clean break along line Y1 results.

During the breaking operation, an air cushion is generated between supporting mat 52 and glass plate 12 by means of air nozzle 56. Scratches on the glass plate are thereby avoided.

The air flow also assists in blowing off the glass splinters produced in the breaking operation. After the breaking operation, second horizontal suction bar 40 is disconnected from portion 102a so that the latter slides back down on second conveyor belt 32, while the formation of scratches on glass plate 12 is avoided due to the air cushion. Meanwhile, first horizontal suction bar 39 is still maintaining the upper portion 102b in its position.

For breaking laminated glasses including a foil, the complete separation of the two portions may further require that the foil is divided mechanically by means of a blade or thermally by heat supply.

The lower portion 102a is then transferred to the next breaking station 70 where, in the example of FIG. 5, the Y trim is broken off along scoring line Y0 by means of second horizontal break bar 80, as described earlier already. The air cushion generated by air nozzle 56 between supporting mat 52 and glass plate 12 avoids that undesired scratches are made on the lower portion 102a while it is being removed.

Ultimately, the X trim is broken off along scoring line X0 by means of second vertical break bar 86, and the remainder is discharged from the installation via post-processing station 90.

After having transferred the lower portion 102a to breaking station 70, the upper portion 102b is lowered onto second conveyor belt 32 by means of first horizontal suction bar 39. In analogy to the procedure steps for breaking subplate 102 along line Y1, portion 102b is, according to FIG. 5, separated into two portions 102c and 102d along scoring line Y2.

Subsequently, according to FIG. 5, the portion 102c is separated into further portions along scoring lines X0, Z1, and Z2 in breaking station 70. Finally, the portion 102d is transferred to the breaking station, and the X trim is removed by breaking along scoring line X0 shown in FIG. 5.

In analogy to what has been described above, the remainder 101 of glass plate 10 is separated into several portions.

The cut portions are then forwarded to further treatments or to intermediate storage.

By using a horizontal breaking device together with vertical breaking devices, it is possible to maintain the original orientation of the glass plate resp. of the portions that have been cut therefrom. This eliminates the need of rotating particularly the cut portions, thereby reducing the processing time. The glass plate portions are merely subject to a translational horizontal and possibly vertical displacement, thereby providing a simplified handling and also reducing the risk of damaging the edges, amongst others.

The respective breaking devices and suction bars act upon the rear side of the glass plate from the back, so that its front side remains untouched. The risk of damaging e.g. the coating of coated glass plates is thereby reduced.

Furthermore, due to the vertical arrangement of the installation, the glass plate rests on the conveyor belt with its own weight, and the conveyor belt thus provides a reference plane for the alignment of the glass plate in each station. Stops for positioning the glass plate, as they are used in horizontally arranged installations of the prior art, can therefore be omitted.

From the preceding description, numerous modifications are apparent to those skilled in the art without leaving the scope of the invention as defined by the claims.

Thus, depending on the field of application of the installation, it may be advantageous to select the angle alpha enclosed between the supporting surface and the vertical in the range of 0 to 10 degrees or in the range of 0 to 45 degrees. The choice of a small angle offers the above-described advantage that the glass plates can be taken over directly from a storage rack or a subplate loader without additional tilting. Yet, even in the case of a greater angle alpha, the advantage remains that the lateral dimensions of the installation are smaller than in installations of the prior art where the glass plates are cut in the horizontal position.

For breaking the glass plate, instead of a break bar, a kind of roller or ball may be used which is guided along the scoring line with a certain pressure.

Furthermore, instead of first horizontal suction bar 39, a gripper or a suitable gripping device may be used for holding the upper portion of the subplate (portion 102b in FIG. 5) laterally or in the upper edge area during the breaking operation. In order to lift the subplate or to lower the portion from which is has been cut, the gripper resp. gripping device is displaceable in the x direction.

It is also conceivable to omit second suction bar 40. Since the glass plate is slightly inclined with respect to the vertical during the breaking operation, its own weight counteracts the pressure of the break bar so that a forward tipping over of the glass plate is avoided.

Furthermore it is also conceivable to design cutting and breaking station 30 as separate stations such that a glass plate is first scored e.g. in feeder station 20 and then transferred to station 30 for breaking it along the scoring lines. Since the second supporting surface 31 is thus no longer required as a rigid wall during cutting, it may be designed similarly as that of breaking station 70 so that the scored glass plate is e.g. merely supported at its edges during the breaking operation.

### List of Reference Numerals

10 glass plate
11 lower edge of glass plate 10
12 glass plate at cutting and breaking station 30
13 rear side of glass plate 12
15 glass plate at breaking station 70
16 lower edge of glass plate 15
20 feeder station
21 first supporting surface
22 first conveyor belt
23 first vertical suction bar
30 cutting and breaking station
31 second supporting surface
32 second conveyor belt
33 cutting bridge
34 gripper
39 first horizontal suction bar
40 second horizontal suction bar
41 first vertical break bar
42 first horizontal break bar
45 bar
46 left-hand chain
47 right-hand chain
49 roller
50 roller
51 upward displacement direction of suction bar 39
52 supporting mat
53 suction head
54 direction in which suction head 53 is displaceable
55 direction in which the first horizontal break bar is displaceable
56 air nozzle
57 direction in which suction head on suction bar 40 is displaceable
70 breaking station
72 third conveyor belt
73 fourth conveyor belt
75 left-hand rail
76 right-hand rail
77 third horizontal suction bar
78 counterpressure bar
79 direction in which the third horizontal suction bar is displaceable
80 second horizontal break bar
81 direction in which the broken trim of glass plate 15 falls
82 front edge of second horizontal break bar
84 second vertical suction bar
85 third vertical suction bar
86 second vertical break bar
90 post-processing station
101 left-hand portion of glass plate 10
102 right-hand portion (subplate) of glass plate 10
102a lower portion of subplate 102
102b upper portion of subplate 102
102c lower portion of portion 102b
102d upper portion of portion 102b
103 lower edge of subplate 102
104 upper edge of subplate 102
alpha angle between the glass plate supporting surface and the vertical
x vertical axis
y horizontal axis
X0 vertical scoring line for breaking off the X trim (X
zero cut line)
X1 vertical scoring line
Y0 horizontal scoring line for breaking off the Y trim
(Y zero cut line)
Y1, Y2 horizontal scoring lines
Z1, Z2 vertical scoring lines

1. Device (30, 70) for dividing a glass plate, comprising
a supporting surface (31, 52, 73) for supporting the glass plate in an essentially vertical position, characterized by
at least one horizontal breaking device (39, 40, 42) for breaking the glass plate (102, 102b) along a line (Y1, Y2) that extends essentially horizontally.

2. Device according to claim 1, characterized in that it further comprises at least one vertical breaking device (23, 41, 84, 85, 86) for breaking the glass plate (10, 102, 102a-d) along a line (X0, X1, Z1, Z2) that extends essentially vertically.

3. Device according to claim 1, characterized in that the horizontal breaking device (39, 40, 42) is displaceable in the vertical direction.

4. Device according to claim 1, characterized in that the horizontal breaking device (39, 40, 42) includes at least one break bar (42).

5. Device according to claim 1, characterized in that it comprises holding means (39) allowing to hold the glass plate (102, 102b) above the essentially horizontally extending line (Y1, Y2).

6. Device according to claim 5, characterized in that the holding means (39) are integrated in the supporting surface (31) and are displaceable together with the supporting surface (31) in the vertical direction.

7. Device according to claim 1, characterized in that the supporting surface (31) comprises bars (45) that are attached in an articulated manner.

8. Device according to claim 5, characterized in that the holding means (39) comprise suction devices (53) that are connectable to the glass plate (13) by partial vacuum.

9. Device according to claim 1, characterized in that it comprises another horizontal breaking device (77, 78, 80) provided with a break bar (80) whose profile is wedge-shaped.

10. Device according to claim 1, characterized in that it comprises a multiple of air nozzles (56) for generating an air cushion between the supporting surface (52) and the glass plate (12).

11. Device according to claim 1, characterized in that it comprises conveyor means (22, 32, 42) for horizontally displacing the glass plate (10) resp. portions (102, 102a-d) that have been separated therefrom.

12. Installation (20, 30, 70, 90) for processing glass plates with a device according to claim 1.

13. Method for dividing a glass plate (102, 102b) that is in an essentially vertical position, characterized in that it is broken at a breaking station (30) along a first line (Y1, Y2) that extends essentially horizontally during the breaking process.

14. Method according to claim 13, characterized in that the glass plate (102, 102b), before being broken along the first line (Y1, Y2), is lifted in the vertical direction.

15. Method according to claim 13, characterized in that the glass plate (102, 102b) is divided at the breaking station (30) into an upper portion (102b, 102d) and a lower portion (102a, 102c), then the lower portion (102a, 102c) is removed from the breaking station (30) and then the upper portion (102b, 102d) is either broken along a second line (Y2) that extends essentially horizontally or is removed from the breaking station (30).

16. Method according to claim 13, characterized in that the glass plate (10) is first divided into a left-hand portion (101) and a right-hand portion (102) along a vertically extending line (X1) and then the right-hand portion (102) is broken along the first line (Y1).

17. Method according to claim 13, characterized in that portions (102a, 102c, 102d) that have been broken off at the breaking station (30) are supplied to a further breaking station (70) where they are broken along a horizontal line (Y0) and/or a vertical line (X0, Z1, Z2).

18. Method according to claim 13, characterized in that the glass plate (102, 102b) is supplied to the breaking station (30) laterally.

19. Method according to claim 13, characterized in that the portions (102, 102a, 102c, 102d) broken off from the glass plate (10) are transported exclusively translationally inside the breaking station (30) and are then removed translationally from the breaking station (30).
